(19) United States
(12) Patent Application Publication
(10) Pub. No.: US 2010/0297534 A1
(43) Pub. Date: Nov. 25, 2010

(54) Seal Structures for Solid Oxide Fuel Cell Devices

(75) Inventors: Thomas Dale Ketcham, Big Flats, NY (US); John Stephen Rosettie, Corning, NY (US); Dell Joseph St. Julien, Watkins Glen, NY (US); Sujanto Widjaja, Corning, NY (US)

Correspondence Address: CORNING INCORPORATED, SP-TI-3-1, CORNING, NY, 14831, US

(73) Assignee: CORNING CORPORATED

(21) Appl. No.: 12/864,149

(22) PCT Filed: Jan. 27, 2009
(86) PCT No.: PCT/US2009/000532

§ 371 Date: Jul. 22, 2010

Related U.S. Application Data
(60) Provisional application No. 61/062,972, filed on Jan. 30, 2008.

(51) Int. Cl. H01M 2/08; H01M 8/00

(52) U.S. Cl. 429/508; 429/535

(57) ABSTRACT

Disclosed are seals and seal structures for use in electrochemical devices such as solid oxide fuel cell devices. Exemplary seal structures are configured such that at least a portion of the interface between the seal and electrolyte sheet deviates from planarity by extending either (i) upwardly and inwardly (ii) or downwardly and inwardly, toward the active portion of the electrolyte sheet surface where one or more device electrodes are deposited. By angling the seal portion of the electrolyte sheet, the sharpness of any resulting bends or deformations that may occur during use can be reduced, thus reducing the likelihood of any cracks forming in the typically high stress regions of the electrolyte sheet. Further, preferably at least a portion of the electrolyte sheet contacting the seal composition, the seal-electrolyte interface may deviate from planarity by at least 0.1 mm from the seal-electrolyte interface, where the deviation from planarity extends normal to the seal or inwardly toward the active surface region of the electrolyte sheet. Also disclosed are methods for manufacturing the inventive seal structures and electrochemical device assemblies comprising same.

This application claims the benefit of priority under 35 U.S.C. §119 (e) of U.S. Provisional Application Ser. No. 61/062,972 filed on Jan. 30, 2008.

### STATEMENT REGARDING FEDERALLY SPONSORED RESEARCH FOR DEVELOPMENT

This invention was made with Government support under Cooperative Agreement 70NANB4H3036 awarded by the National Institute of Standards and Technology (NIST). The United States Government may have certain rights in this invention.

### BACKGROUND OF THE INVENTION

1. Field of the Invention

The present invention relates to solid oxide fuel cells and, more specifically, to structures for the seal-electrolyte interface, and seal configurations that can reduce the stress and resulting fractures during operation of solid oxide fuel cell devices.

2. Technical Background

Solid oxide fuel cells (SOFC) have been the subject of considerable research in recent years. Solid oxide fuel cells convert the chemical energy of a fuel, such as hydrogen and/or hydrocarbons, into electricity via electro-chemical oxidation of the fuel at temperatures, for example, of about 600° C. to about 1000° C. A typical SOFC comprises a negatively charged oxygen-ion conducting electrolyte sandwiched between a cathode layer and an anode layer. Molecular oxygen is reduced at the cathode and incorporated in the electrolyte, wherein oxygen ions are transported through the electrolyte to react with, for example, hydrogen at the anode to form water.

Some SOFC devices such as those described in U.S. Pat. No. 6,663,881 B2 include electrode-electrolyte structures comprising a solid electrolyte sheet incorporating a plurality of positive and negative electrodes bonded to opposite sides of a thin flexible inorganic electrolyte sheet.

Other designs, such as those disclosed in U.S. Pat. No. 5,273,837 describe thermal shock resistant solid oxide fuel cells and thin, inorganic sheets that have strength and flexibility to permit bending without fracturing and have excellent temperature stability over a range of fuel cell operating temperatures.

SOFC devices are typically subjected to large thermal-mechanical stresses due to the high operating temperatures and potentially rapid temperature cycling of the device. Such stresses can result in deformation of device components and can adversely impact the operational reliability and lifetime of SOFC devices. For example, thin electrolyte sheets that support anode(s) and cathode(s) may suffer from fracture near the seal-electrolyte interface. Similarly, anode or cathode supported electrolytes may suffer from fracture at or near the seal-electrolyte, or seal-electrode-electrolyte interface.

The electrolyte sheet of a SOFC device is typically sealed to a frame support structure in order to keep fuel and oxidant gases separate. In some cases, the thermal mechanical stress and resulting deformation may be concentrated at the interface between the electrolyte sheet and the seal, resulting in a failure of the seal, the electrolyte sheet, and/or the SOFC device. When a thin, flexible ceramic sheet is utilized as the electrolyte in a SOFC device, there is a higher likelihood of premature failure of the electrolyte sheet itself. Differential gas pressure and interactions between the device, the seal, and the frame due to temperature gradients and the mismatch of component properties (e.g., thermal expansion and rigidity) may lead to increased stress at the seal and the unsupported region of the electrolyte sheet adjacent to the seal. Large electrolyte sheets are especially subject to failure caused by stress induced fracturing of electrolyte sheet wrinkles, also referred to as self buckling or self corrugation.

Thus, there is a need to address the thermal mechanical integrity of solid oxide fuel cell seals and electrolyte sheets, and other shortcomings associated with solid oxide fuel cells and methods for fabricating and operating solid oxide fuel cells. These needs and other needs are satisfied by the articles, devices and methods of the present invention.

### SUMMARY OF THE INVENTION

The present invention addresses at least a portion of the problems described above through the use of novel seal-electrolyte interface and/or seal structures and novel methods for manufacturing same.

According to one aspect of the present invention an electrochemical device assembly comprises: (A) at least one electrolyte sheet comprising an electrochemically active area and an electrochemically inactive area, wherein the inactive area comprises a seal area and a streetwidth area, and wherein the streetwidth area is interposed between the active surface region and the seal area; and (B) a seal, the seal contacting at least a portion of the electrolyte sheet seal area and forming seal-electrolyte sheet interface, wherein at least a portion of seal-electrolyte sheet interface deviates from planarity by extending either: (i) upwardly and inwardly toward the active surface region of the electrolyte sheet, or (ii) downwardly and inwardly toward the active surface region of the electrolyte sheet. According to some embodiments of the invention at least a portion of the seal electrolyte sheet interface contacting the seal composition deviates from planarity with respect to a reference plane of the seal-electrolyte interface: (i) with angular deviation of least 0.5 degrees, where the angular deviation from planarity extends inwardly toward said active area of said electrolyte sheet; and/or (ii) such that at least a portion of the electrolyte sheet contacting the seal composition (i.e., at leas a portion of seal-electrolyte interface) deviates from planarity with respect to said reference plane by at least 0.1 mm in the direction normal to the reference plane.

According to another aspect of the present invention an electrochemical device assembly comprises: (A) a frame having at least one support surface; (B) at least one electrolyte sheet comprising an electrochemically active area and an electrochemically inactive area, wherein the inactive area comprises a seal area and a street width area, and wherein the street width area is interposed between the active surface region and the seal area; and (C) a seal composition interposed between and contacting at least a portion of the frame support surface and at least a portion of the electrolyte sheet seal area; wherein at least a portion of the seal-electrolyte interface deviates from planarity by extending either (i) upwardly and inwardly or (ii) downwardly and inwardly toward the active surface region of the electrolyte sheet. According to some embodiments of the invention at least a portion of the seal electrolyte sheet interface contacting the seal composition deviates from planarity with respect to a reference plane of the seal-electrolyte interface: (i) with angular deviation of least 0.5 degrees, where the angular deviation from planarity extends inwardly toward said active area of said electrolyte sheet; and/or (ii) such that at least a portion of the electrolyte sheet contacting the seal composition (i.e., at leas a portion of seal-electrolyte interface) deviates from planarity with respect to said reference plane by at least 0.1 mm in the direction normal to the reference plane.

In one embodiment, the present invention provides an electrochemical device assembly comprised of an electrolyte sheet supported by and connected to a frame. The frame comprises a seal support surface. In some embodiments the seal support surface is the top surface of the frame. The electrolyte sheet comprises an electrochemically active area and an electrochemically inactive area. The inactive area of this embodiment further comprises a seal area and a street width area, wherein the street width area is interposed between the active surface region and the seal area. The electrochemically active area of the electrolyte is the area where both anode(s) and cathode(s) are separated by an electrolyte. A seal composition is interposed between and contacting at least a portion of the support surface and at least a portion of the electrolyte sheet seal area. Still further, at least a portion of the electrolyte sheet contacting the seal composition, the seal-electrolyte interface, extends either upwardly and inwardly toward the active surface region of the electrolyte sheet, or downwardly and inwardly toward the active surface region of the electrolyte.

In another embodiment, the present invention also provides a method for manufacturing an electrochemical device assemblies described above. For example, the method can generally comprise the steps of providing a frame having a support surface and providing a device comprising an electrolyte sheet. At least a portion of the electrolyte sheet and the frame support surface are then connected to one another by a seal composition such that the portion of the electrolyte sheet connected to the frame extends upwardly toward or downwardly toward a second (active) portion of the electrolyte sheet and away from the reference plane. For example, at least a portion of the electrolyte sheet contacting the seal composition may deviate from planarity by at least 0.1 mm in the direction normal to the reference plane, where the deviation from planarity extends normal to the reference plane or inwardly toward the active surface region of the electrolyte sheet. The method may be utilized with generally planar sheets of flexible electrolyte. According to some embodiments, this method may also be utilized with generally planar sheets of electrode supported electrolyte, that when thin and strong, can be flexible.

The embodiments of the present invention provides advantage(s) to electrochemical devices comprising ceramic sheets (such as electrolytes) and seal structures, by advantageously attaching a thin electrolyte sheet to a support (e.g., frame) so as to minimize device failure due to thermal mechanical stress. The present invention can be also applied to electrochemical devices comprising ceramic electrolytes and seal structures useful in attaching a thin electrode supported electrolyte to a frame support to advantageously minimize device failure due to thermal mechanical stress.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain embodiments of the instant invention and together with the description, serve to explain, without limitation, the principles of the invention.

FIG. 1 is a schematic illustration of a solid electrochemical device assembly.

FIG. 2 illustrates a finite element analysis diagram of the stresses that can occur in the electrolyte sheet of a multi-cell rectangular fuel cell device similar to that shown in FIG. 1.

FIG. 3 is a schematic illustration of a electrochemical device assembly, indicating the typical failure locations on a rectangular electrolyte sheet of FIGS. 1 and 2.

FIG. 4 is a schematic cross-section of a seal structure corresponding to FIGS. 1-3 and illustrates subsequent buckling or bow out of the electrolyte sheet resulting from thermo mechanical stresses.

FIG. 5 is a schematic illustration of an exemplary electrochemical device according to one embodiment of the present invention.

FIG. 6A is a schematic illustration of an exemplary seal structure according to one embodiment of the present invention.

FIG. 6B is a schematic illustration of an exemplary seal structure according to another embodiment of the present invention.

FIG. 7 is a schematic illustration of an electrochemical device according to one embodiment of the present invention.

FIG. 8 is a schematic illustration of an electrochemical device according to one embodiment of the present invention.

FIG. 9 is an illustration of an exemplary frame according to one embodiment of the present invention. The frame as shown has a textured top support surface comprised of periodic height perturbations and an angular deviation from planarity.

FIG. 10A illustrates an electrochemical device according to one embodiment of the present invention and as prepared pursuant to the Examples. The electrochemical device comprises a circular frame having a top support surface configured with a 2.5 degree angular deviation from planarity.

FIG. 10B illustrates an electrochemical device according to one embodiment of the present invention and as prepared pursuant to the Examples. The electrochemical device comprises a circular frame having a top support surface configured with a 5.0 degree angular deviation from planarity.

FIG. 11 illustrates data from a measurement of the deflection across the diameter of an electrolyte sheet according to one embodiment of the present invention.

FIG. 12A shows data of failure probability vs. interior gas pressure for inventive and comparative devices tested at 725° C.

FIG. 12B shows data of failure probability vs. interior gas pressure for inventive and comparative devices tested at 25° C.

FIG. 13 is a schematic illustration of an exemplary electrochemical device according to one embodiment of the present invention.

FIG. 14 is a schematic illustration of an exemplary electrochemical device according to one embodiment of the present invention.

FIG. 15 is a schematic illustration of two exemplary electrochemical devices according to one embodiment of the present invention.

FIG. 16 is a schematic illustration of two exemplary electrochemical devices and a frame made of the seal composition according to one embodiment of the present invention.

### DETAILED DESCRIPTION

The present invention can be understood more readily by reference to the following detailed description, drawings, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular embodiments only and is not intended to be limiting.

The following description of the invention is provided as an enabling teaching of the invention in its currently known embodiments. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

Disclosed are materials, compounds, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. If there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

As used herein, the term “reference plane” corresponds to the reference plane of the seal-electrolyte interface, which is defined or calculated in the following manner: A plane is determined by three points on the outer periphery of the seal-electrolyte interface (the points are determined by having the seal-electrolyte interface situated in a normal Cartesian coordinate system). The seal-electrolyte interface (will generally correspond to, or is situated near the Z=0 plane) will lie in the X-Y plane, such that the seal composition and the frame will be situated below the seal-electrolyte interface (i.e., lower along the Z-axis). The lowest Z point on the seal-electrolyte interface is than chosen as the first interim point for the interim plane, or the origin (X=0, Y=0, Z=0). A second interim point is determined by the point on the seal-electrolyte interface that is situated the maximum distance (in X, Y and Z plane) from the first interim point. The third interim point is now determined by a point about half way along the outer periphery of the seal-electrolyte interface in either (X or Y) direction. These three interim points now define an interim plane. The seal-electrolyte interface and the frame are now rotated in the coordinate system such that the interim plane coincides with the Z=0 plane. The Z=0 plane now becomes the reference plane and the seal-electrolyte interface and will have at least 3 points touching or crossing the reference plane.

The angle of the electrolyte seal interface or the deviation from planarity of the seal-electrolyte interface can now be determined relative to this reference plane. Some parts of the seal-electrolyte interface may be located above and/or below the reference plane. For example, if the seal-electrolyte interface has a textured geometry, some points on the interface will be located above the reference plane, and some points will be located below the reference plane. In such embodiment, the deviation from the seal-electrolyte interface from the reference plane is determined by the sum of the distances from the reference plane to the maximum and minimum values of Z (on the outer periphery) of the seal-electrolyte interface. In some cases where the reference plane intersects the entire outer periphery of the seal electrolyte interface the height (Z) deviation of the seal-electrolyte interface will be zero. However, in this embodiment there can be a deviation of the seal-electrolyte interface from the reference plane measured by an angle of the slope of the seal-electrolyte interface with respect to the reference plane. In other embodiments, there can be both a deviation in height and an angular deviation over at least part of the seal-electrolyte interface.

In some embodiments of the present invention, a portion of the seal-electrolyte interface deviates from planarity and the deviation is an angular deviation, but the height of the deviation is less than 0.1 mm, and where the angular deviation of the seal-electrolyte interface is not intersected by the reference plane. In these embodiments a final reference plane R can be constructed parallel to the first reference plane, where the second, such that the final reference plane R intersects the seal-electrolyte interface on the portion of the seal-electrolyte interface where there is an angular deviation from planarity. The coordinates and hence the angle and deviation from planarity of the seal-electrolyte interface can then be determined, for example, using laser measurement systems and or contact measurement systems.

As used herein, the singular forms “a,” “an” and “the” include plural referents unless the context clearly dictates otherwise. Thus, for example, reference to a “component” includes embodiments having two or more such components, unless the context clearly indicates otherwise.

“Optional” or “optionally” means that the subsequently described event, element, or circumstance can or cannot occur, and that the description includes instances where the event, element, or circumstance occurs and instances where it does not. For example, the phrase “optional component” means that the component can or can not be present and that the description includes both embodiments of the invention including and excluding the component.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, refers to the ratio of the weight of the component to the total weight of the composition in which the component is included, expressed as a percentage.

In order to manufacture a thin electrolyte that can be advantageously utilized in the present invention, a thin sheet or layer comprising the green unsintered material, is first produced. The green unsintered material is then sintered to provide a sintered ceramic sheet with flexibility sufficient to permit a high degree of bending without breakage under an applied force. Flexibility in the sintered ceramic sheets is sufficient to permit bending to an effective radius of curvature of less than 20 centimeters or some equivalent measure, preferably less than 5 centimeters or some equivalent measure, more preferably less than 1 centimeter or some equivalent measure.

By an “effective” radius of curvature is meant that radius of curvature which may be locally generated by bending in a sintered body in addition to any natural or inherent curvature provided in the sintered configuration of the material. Thus, the resultant curved sintered ceramic electrolyte sheets can be further bent, straightened, or bent to reverse curvature without breakage.

The flexibility of the electrolyte sheet will depend, to a large measure, on layer thickness and, therefore, can be tailored as such for a specific use. Generally, the thicker the electrolyte sheet the less flexible it becomes. Thin electrolyte sheets are flexible to the point where toughened and hardened sintered ceramic electrolyte sheet may bend without breaking to the bent radius of less than 10 mm. Such flexibility is advantageous when the electrolyte sheet is used in conjunction with electrodes and/or frames that have dis-similar coefficients of thermal expansion and/or thermal masses.

The electrolyte sheet preferably has an average thickness t that is greater than 4 micrometers and less than 100 micrometers, preferably less than 45 micrometers, more preferably between 4 micrometers and 30 micrometers, and most preferably between 5 micrometers and 18 micrometers. Lower average thickness is also possible. The lower limit of thickness is simply the minimum thickness required to render the structure amenable to handling without breakage.

One way of electrically connecting multiple cells on a single electrolyte sheet, either in series or in series plus parallel, is by using vias and via pads. The vias carry electric current and voltage from one side of the electrolyte sheet to another. The via pads electrically connect the via to an electrode on one side of the electrolyte sheet. The vias are made by punching via holes in the green electrolyte before sintering or after sintering. The via holes can be small, less than 100 microns, and in linear patterns or other patterns between cells to suit the cell pattern and cell electrical connection scheme. After the sheet is sintered, the cells can be printed and sintered. After the cells are sintered, then the via holes can be filled with a conductor such as Ag—Pd or Pt—Au—Pd, in come cases by printing and sintering these electrical conductors. At the same time, or in separate steps, the via pads that connect the cells with the via conductors are printed and sintered. In a series electrical connection, the anodes of one cell are connected to the cathodes of an adjacent cell in order to build voltage. These connections can be done with each adjacent cells except for the last cells. The last cathode on one end and the last anode on the opposite end of a series connection can be connected to the outside circuit, or can be connected to a bus bar that is connected to the outside circuit, to carry the current, voltage and power the fuel cell device creates. US patent application #2004/0028975 and US patent application #2007/172713, incorporated by reference herein, describe vias, via pads and bus bars in more detail. Generally the process steps occur in descending order of sintering temperature for the various device constituents.

The inactive electrolyte area between the inner periphery of the seal electrolyte interface and the electrochemically active area of the sheet is termed the street width. It is preferred that the street width be in the range of about 1 mm to about 25 mm and preferably in the range of about 5 mm to about 10 mm between the electrodes and the seal area.

In the embodiments where the electrolyte-seal interface deviates from planarity by more than 0.1 mm, it is preferred than the deviations occur in smooth curves along the outer periphery of the seal electrolyte interface. It is preferred that the smooth curves have a radius of curvature of 2 cm or greater, more preferably 5 cm or greater and most preferably 10 cm or greater. The radius of curvature is measured at and along the outer periphery of the seal electrolyte interface.

As briefly introduced above, the present invention provides seal structures that can reduce and/or prevent device failure due to thermal mechanical stresses. The proposed methods can lead to improved thermal mechanical integrity and robustness of a solid oxide fuel cell device. Several approaches to improve thermal mechanical integrity of fuel cell components are disclosed herein.

Although the seals structures and methods of the present invention are described below with respect to a solid oxide fuel cell, it should be understood that the same or similar seal structures and methods can be used in other applications where a need exists to seal a ceramic sheet to a support frame. Accordingly, the present invention should not be construed in a limited manner.

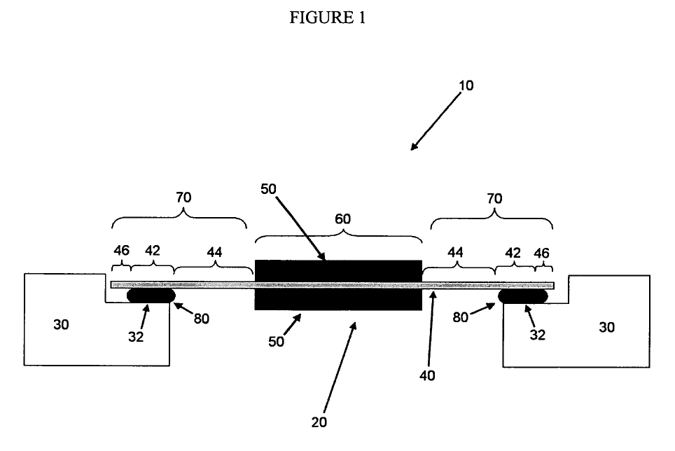

With reference to FIG. 1, a solid oxide fuel cell device assembly 10 is shown, comprising an electrode assembly 20 supported by a frame 30. The electrode assembly is comprised of a ceramic electrolyte sheet 40 sandwiched between two electrodes, 50, typically an anode and a cathode. The ceramic electrolyte can comprise any ion-conducting material suitable for use in a solid oxide fuel cell. The electrolyte can comprise a polycrystalline ceramic such as zirconia, yttria, scandia, ceria, or a combination thereof, and can optionally be doped with at least one dopant selected from the group consisting of the oxides of Y, Hf, Ce, Ca, Mg, Sc, Nd, Sm, Eu, Gd, Tb, Dy, Ho, Er, Tm, Yb, Lu, In, Ti, Sn, Nb, Ta, Mo, W, or a mixture thereof. The electrolyte can also comprise other filler and/or processing materials. An exemplary electrolyte is a planar sheet comprised of zirconia doped with yttria, also referred to as yttria stabilized zirconia (YSZ) or partially stabilized zirconia (PSZ) depending upon the exact composition and microstructure. Solid oxide fuel cell electrolyte materials are commercially available (for example, TZ-3Y material (tetragonal, partially stabilized zirconia with 3 mole % yttria), available from Tosoh Corporation of Tokyo, Japan) and one of skill in the art could readily select an appropriate ceramic electrolyte material. Partially stabilized zirconias are especially advantageous because their superior strength and toughness produces an electrolyte that may be bent without breaking and that exhibits a superior flaw tolerance as compared to non-toughened materials.

The crystallographic phases of zirconia, stabilized zirconia, partially stabilized zirconia and toughened zirconia are important considerations for the mechanical and ionic conduction of one embodiment of the electrolyte. Zirconia and doped zirconia exist in three major phases, monoclinic, tetragonal, and cubic. In pure zirconia without dopants in air, cubic only appears at extreme temperatures of greater than about 2400° C., tetragonal is stable only at temperatures above about 1050-1200° C. and below 2400° C. and monoclinic is the room temperature phase and is stable up to about 1050-1200° C. Stabilized zircoina refers to the cubic phase where the cubic phase is “stabilized” with dopants at all temperatures. In typical commercial products, the cubic stabilized phase of zircoina is achieved by doping the zirconia with high levels of yttria, calcia or magnesia. Yttria dopant levels of 8 mole % Y203 or more are needed and higher levels of CaO and MgO are needed to achieve a room temperature stable cubic phase. Cubic stabilized zirconia with about 8 to about 12 mole % yttria is referred to as yttria stabilized zirconia, YSZ. The cubic phase of zirconia can also be stabilized by most rare earth oxides, but at similar, high levels of dopants. Partially stabilized zirconia has less dopant and is not fully cubic, having other phases present. Partially stabilized zirconia refers to several types of microstructure: (i) a two phase body with both the tetragonal phase and cubic phase; (ii) a single phase body with tetragonal phase only; (iii) a two phase body with monoclinic phase and cubic phase; (iv). a three phase body with tetragonal, monoclinic and cubic. Zirconia can be partially stabilized with yttria. The most widely used high strength; fine grain size, partially stabilized zirconia, is zirconia doped with 3 mole % Y2O3. It is mainly tetragonal phase but often has a minor amount of cubic phase, depending upon the sintering temperature and exact composition. Partially stabilized zirconia with 2 mole % Y2O3, 3 mole % Y2O3, 4 mole % Y2O3 and 6 mole % Y2O3 have been made as commercially available powders. Partially stabilized zirconia with 9-12 mole % CeO2, has also been made as commercially available powders. Zirconia can also be partially stabilized by most rare earth oxides, Sc2O3 and In2O3. Additions of TiO2, SnO2 can reduce the amount of other dopant (yttria, rare earth oxides, etc.) needed to achieve a room temperature tetragonal phase. YNbO4, YTaO4, rare earth (also Sc, In), (Nb, Ta)O4 and Ca MoO4, MgWO4 and combinations of rare earths, Ca, Mg and Nb, Ta, W, Mo as oxides can also can help retain the tetragonal phase or increase the toughness at room temperature when added to zircoina as a solid solution.

A transformation toughened zirconia usually refers to a body with meta-stable tetragonal phase grains or precipitates which, under the high stress near a crack tip can martensitically transform to the monoclinic phase. The volume expansion of the grain or precipitate caused by this phase transformation, about 5% (along with some shearing and twins) alters the stress state near the crack tip, effectively squeezing the crack closed. A transformation toughened zirconia that is mostly tetragonal phase with a small grain size is also called tetragonal zirconia polycrystals (TZP). Toughened, partially stabilized zirconia, has a tetragonal phase to improve toughness.

Other electrolytes such as lanthanium aluminum gallate, beta alumina and beta” alumina may be toughened by tetragonal zirconia. Typically 5 volume % or more tetragonal zirconia is needed to improve toughness. For some electrolytes, tetragonal zirconia is not thermodynamically or kinetically stable. In those cases and others, one can improve toughness by adding second phases in the form of particles, plates or flakes, fibers, whiskers and ribbons. Alumina fibers or whiskers in ceria based electrolytes could prove effective. Once again about 5 volume % or more of the second phase may be needed to effectively improve toughness effectively.

The electrode assembly 20 is typically connected to the support frame 30 by a seal composition 80 disposed between in contact with a top (seal) support surface 32 of the frame and a seal area 42 of the electrolyte sheet 40. As shown in FIG. 1, the seal area 42 of the electrolyte sheet is typically positioned either coplanar with the inner active area of the electrolyte sheet or, alternatively, at least in a plane parallel to the plane of the inner active area of the electrolyte sheet. The seal of a solid oxide fuel cell can comprise any material suitable for use in sealing an electrolyte and a frame of a solid oxide fuel cell. For example, the seal can comprise a glass frit composition, or a metal, such as a braze or a foamed metal. A glass frit seal can further comprise ceramic materials and/or coefficient of thermal expansion matching fillers. It is typically preferred that the seal is a bond sintered from a glass frit.

As shown, the electrodes 50 (comprised of at least one anode and at least one cathode), can be positioned on opposing surfaces of the electrolyte. However, in an alternative arrangement (not shown), a solid oxide fuel cell can comprise a single chamber, wherein both the anode and the cathode are on the same side of the electrolyte. The electrolyte can also be of the electrode supported variety, either anode of cathode supported. The electrolytes, including electrode supported electrolyte sheets may be flexible.

The electrodes can comprise any materials suitable for facilitating the reactions of a solid oxide fuel cell. The anode and cathode can comprise different or similar materials and no limitation to materials or design is intended. The anode and/or cathode can form any geometric pattern suitable for use in a solid oxide fuel cell. The electrodes can be a coating or planar material positioned parallel to and on the surface of the ceramic electrolyte. The electrodes can also be arranged in a pattern comprising multiple independent electrodes. For example, an anode can be a single, continuous coating on one side of an electrolyte or a plurality of individual elements, such as strips, positioned in a pattern or array.

An anode can comprise, for example, yttria, zirconia, nickel, or a combination thereof. An exemplary anode can comprise a cermet comprising nickel and the electrolyte material such as, for example, zirconia. An exemplary anode can also comprise Cu and ceria mixtures, or doped perovskites such as those based on strontium titanate.

A cathode can comprise, for example, yttria, zirconia, manganate, ferrate, cobaltate, or a combination thereof. Exemplary cathode materials can include, yttria stabilized zirconia, lanthanum strontium manganate, lanthanum strontium ferrate, lanthanum strontium cobaltate and combinations thereof. Also, ceria based materials such as gadolinium doped ceria can be utilized in combination with other materials.

Solid oxide fuel cell components, such as electrode, frame, and seal materials are commercially available and one of skill in the art could readily select an appropriate material for a component of a solid oxide fuel cell.

The area of the electrolyte sheet on which the electrodes are positioned is referred to as the active area 60 of the electrolyte sheet. The remaining outer surface portions 70 of the electrolyte sheet are referred to as the inactive surface areas or portions of the electrolyte sheet. These inactive surface area portions comprise the seal area 42 described above, a streetwidth 44, which refers to the portion between the active area and the seal area of an electrolyte sheet, and an overhanging portion 46.

During fuel cell operation, the electrolyte, frame, and seal can be subjected to operating temperatures of from about 600° C. to about 1,000° C. In addition, these components can experience rapid temperature cycling during, for example, startup and shutdown cycles. The thermal mechanical stresses placed on these components under such conditions can result in significant stress occurring in the street width region of an electrolyte sheet or membrane.

Such stresses can arise from a number of sources. In fuel cell systems utilizing flexible electrolyte and flexible electrode supported electrolyte, the stresses arise typically the result of (i) local self corrugation due to local CTE differences and/or (ii) bending and out of plane deformation of the device caused by global CTE difference between the frame and the device. As used herein, the term “device” denotes an electrolyte sheet sandwiched between at least one pair of electrodes.

Such stresses can also occur if there are temperature gradients between areas in the packet (i.e., frame-device assembly), such as when the device is hotter in some regions than the frame. Such situations are also likely to occur during start up or cool down of a fuel cell stack or device or even during transient conditions where the power output of the device is changing. These stresses can result in subsequent deformation, fracture, or even total failure of the components or the entire fuel cell device, packet, or system.

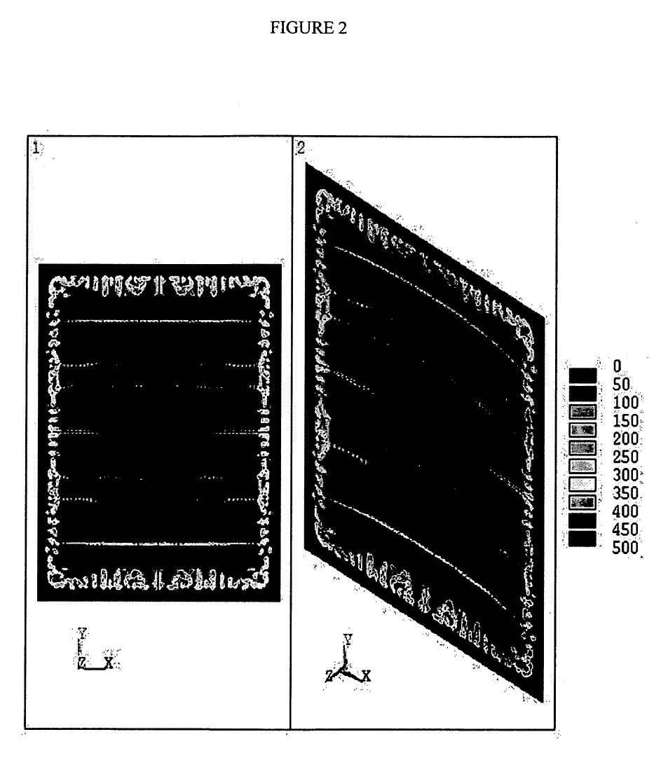

The existence of such stresses can be shown, for example, in FIG. 2, which provides a modeled finite element analysis (FEA) for an exemplary electrolyte “street width” region between the seal and the active area (corresponding to electrode array of an exemplary multi-cell solid oxide fuel cell device). The FEA analysis was conducted under the assumption that the seal was an immovable clamped planar rectangle with slightly rounded corners. The electrolyte sheet was modeled with E-modulus and thermal expansion coefficient of yttria doped zirconia, i.e., 210 GPa and 11.5×10-6/° C. The electrodes and via pads were modeled based upon the assumption that they had the thermal expansion and modulus characteristics of gold. The device was assumed to be stress free at room temperature and in the model the temperature was raised to 725° C. Still further, the metal electrodes were assumed to be elastic such that no plastic deformation was allowed. As shown by the shading gradients, the CTE difference stresses are concentrated in the thin electrolyte near the seals.

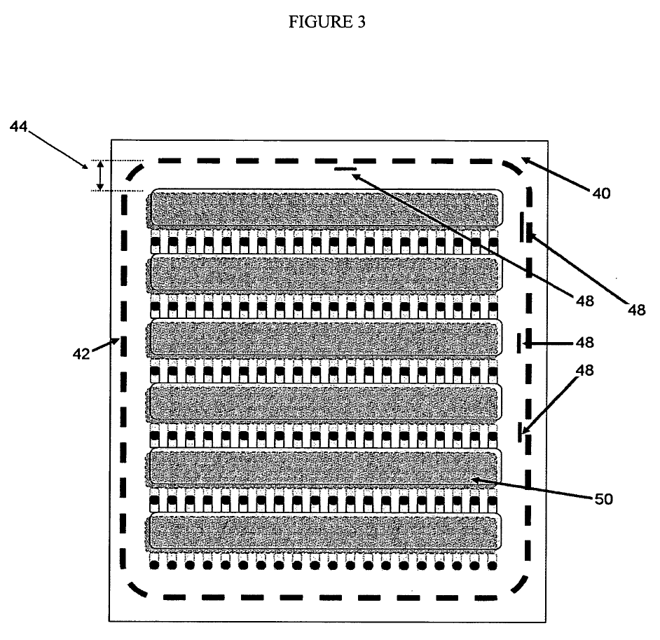

In practice, when solid oxide fuel cell devices mounted to metal frames (e.g., thin electrolyte with multiple electrode pairs,) crack, they typically fracture along the high stressed regions identified in FIG. 2, near the seal region in the electrolyte away from the electrodes and vias. FIG. 3 illustrates a schematic diagram of typical fracture sites 48 in the electrolyte sheet 40 of a solid oxide fuel cell device. The exemplified fuel cell device is representative of a device having a “street width” 44 in the range of about 5 mm-to about 10 mm between the electrodes 50 and the seal area 42. The seals may be formed of a glass or glass ceramic material that can be sintered to zero open porosity in the temperature range of above 750° C. and below 1000° C. and can be of lower thermal expansion material than the frame or the device, or matched (i.e., CTE matched to the frame or the device), or nearly matched. (Note: the upper temperature limitation is not applicable if the system does not contain low melting components such as silver alloys).

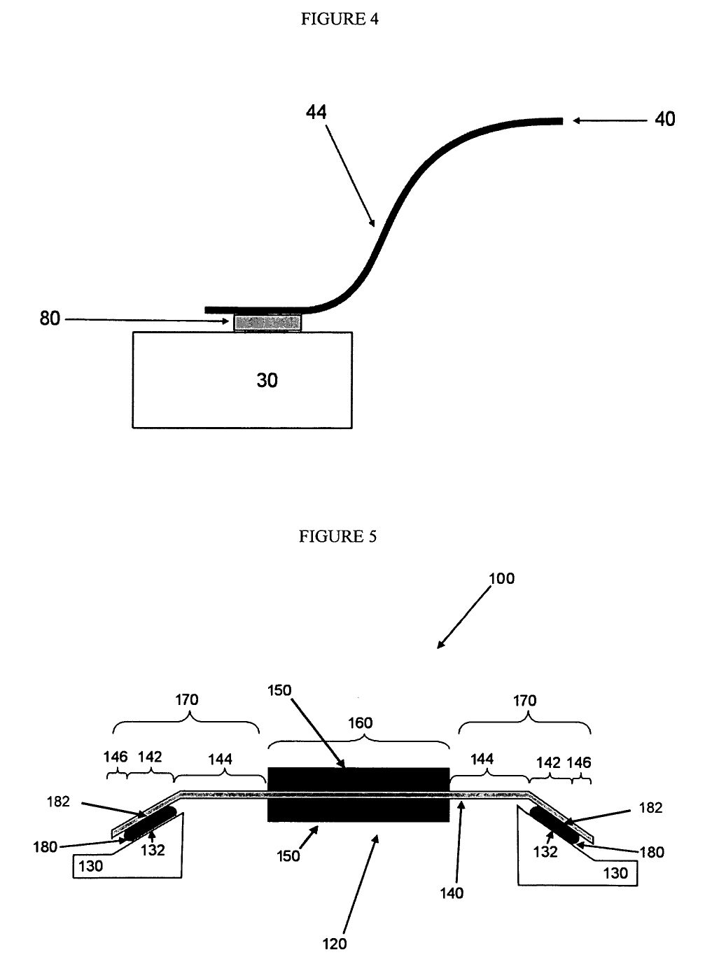

The frames to which the electrolyte sheet is bonded are typically made of stainless steel such as 430 and 446 and have a slightly higher expansion than the device. This puts the devices into compression when cooling from the sealing temperature and causes the device to bow out of plane as further shown in FIG. 4. In particular, FIG. 4 represents a schematic view of an electrolyte sheet 40 sealed to a frame 30 by a seal composition 80. The street width area 44 is shown as having bowed out of plane as a result of typical thermo mechanical stress. As shown in FIG. 3, when the devices fracture, the majority of the cracks or fracture are likely to occur in the bent or bowed street width portion near the seal area of the electrolyte sheet, with the crack often extending parallel to the seal line.

The seal composition itself may also serve as the frame, as described in U.S. application Ser. No. 11/804,020 filed May 16, 2007. Hence, the term frame, as used herein, includes a seal structure or composition that also serves as the frame or can include a frame that is a separate material and or structure than the seal composition.

The embodiments of the present invention provide several approaches to minimize such deformation, fracture, and/or failure. The various approaches can be used individually or in combination, as appropriate, and the present invention is not intended to be limited to a single embodiment. All of the embodiments described herein are intended to describe embodiments containing an electrolyte, an electrolyte and seal, and/or an electrolyte, seal, and frame. The electrolyte sheet may be sandwiched between one electrode pair (i.e., between one anode and one cathode, or between multiple electrode pairs, thus forming a multi cell device.) If an element required for fuel cell operation is not specifically recited, embodiments both including and excluding the element are intended and should be considered part of the invention.

To address the occurrence of stress and the resulting fractures that can occur, the embodiments of the present invention provide solid oxide fuel cell device assemblies having novel seal area configurations wherein at least a portion of the “seal area” of an electrolyte sheet extends upwardly and inwardly toward the inner portion of the electrolyte sheet surface where one or more device electrodes are deposited. By angling the seal portion of the electrolyte sheet, the sharpness of any resulting bends or deformations that may occur during use can be reduced, thus reducing the likelihood of any cracks forming in the typically high stress regions of the electrolyte sheet.

With reference to FIG. 5, a cross section of an exemplary fuel cell device 100 of the present invention is shown. The device comprises an electrode assembly 120 supported by a frame 130. The electrode assembly is comprised of a ceramic electrolyte sheet 140 sandwiched between at least two electrodes 150, shown as an anode 152 and a cathode 154. The electrolyte sheet 140 is further comprised of an inner active area 160 upon which the electrodes are in contact, and also comprising an outer inactive area 170. The outer inactive area of the electrolyte sheet comprises a seal area 142 and a street width area 144. The fuel cell device is representative of a device having a “street width” 144 in the range of about 1 mm to about 25 mm and preferably in the range of about 5 mm to about 10 mm between the electrodes 150 and the seal area 142.

In this embodiment, the frame 130 has a support surface (top surface) 132. A ceramic bonding material or seal composition 180 is interposed between at least a portion of the frame support surface 132 and the seal area 142 of the electrolyte sheet. As further shown, at least a portion of the seal area of the electrolyte sheet, the seal electrolyte interface 182, extends upwardly and inwardly toward the active area 160 of the electrolyte sheet. Thus, in one embodiment of the present invention, at least a portion of the seal-electrolyte interface of the electrolyte sheet is not coplanar with the active area of the electrolyte sheet—i.e., the seal-electrolyte interface is not situated in a plane parallel to the plane of the active area (inner area) of the electrolyte sheet.

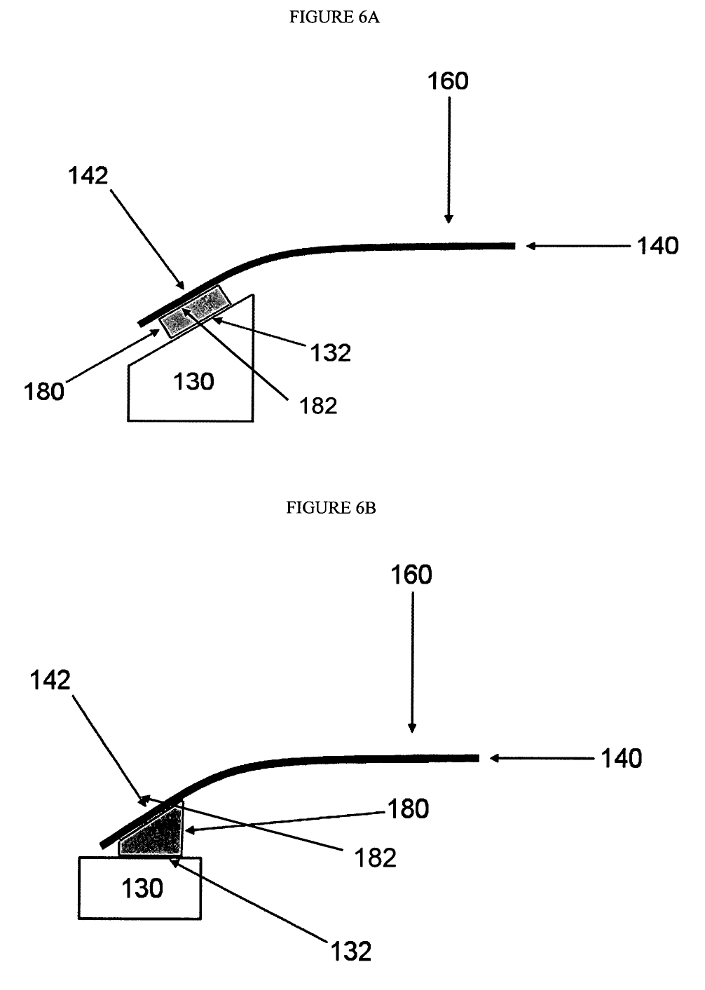

The upwardly and inwardly extending seal area 142 of the electrolyte sheet can, in one embodiment, be provided by the geometry of the frame or support member. For example, as shown in FIG. 6A, a frame or support member 130 can be formed such that the top support surface 132 of the frame extends upwardly and inwardly toward the active area 160 of the electrolyte sheet 140. For example, in the exemplary embodiment shown, the frame 130 can be machined to provide a beveled support surface 132. A substantially uniformly thick bead of the ceramic bonding agent or seal material 180 can be provided on at least a portion of the beveled top surface 132 of the frame or support so that it is interposed between frame support surface 132 and the seal area 142 of the electrolyte sheet. If desired, the bevel can further be provided across the entire support surface (e.g., top surface that supports the seal) portion of the frame. Alternatively, for example, the bevel can be present on only a portion of the frame or its support portion. For example, in a rectangular frame, a bevel can be provided across one, two, three or even all frame edges. If a stamped metal frame is used then the bevel can be stamped into the frame such that the metal thickness remains constant but an angular deviation from planarity (or bevel) is imposed by the bend in the metal. In this embodiment, angular deviation from the seal-electrolyte interface 182 from the reference plane R is measured by the angle θ. (In some embodiments, discussed later herein, the frame may be formed of the seal material, such that the seal and the frame comprise a single, unitary component).

In an alternative embodiment, the upwardly and inwardly extending portion of the electrolyte sheet can be provided by the geometry of the ceramic bonding agent or seal material. For example, as shown in FIG. 6B, a frame or support member 130 can be machined having a top support surface 132 that is substantially planar and that extends substantially parallel to the active area 160 of an electrolyte sheet. A wedge shaped ceramic bonding agent or seal material 180 can be provided on the top support surface 132 of the frame or support so that it is interposed between the frame the seal area 142 of the electrolyte sheet. The seal material can be manipulated such that it has a non-uniform thickness and forms a wedge shape in cross section whereby a top surface portion of the seal material itself actually extends upwardly and inwardly towards the active area of the electrolyte sheet. In this embodiment, angular deviation from the seal-electrolyte interface 182 from the reference plane R is measured by the angle θ.

The wedge shaped geometry of seal material can, for example, be provided by utilizing two fiber mats positioned between the electrolyte sheet and a weight, wherein one fiber mat completely covers the seal area, while the second fiber mat is narrower and covers only an outer portion of the electrolyte within the seal area. The static weight of the second fiber mat can apply increased pressure on the outer portion of the seal such that during a subsequent sintering step, that area thins somewhat relative to the remaining seal portion covered by only the first fiber mat. By selecting varying weights and fiber mat combination, seal geometry having any desired degree of inclination (angular deviation from planarity, or “take off” angle) can be obtained. Alternatively, a thin piece of alumina fiber mat can be submerged or disposed inside a portion of the seal bead between the electrolyte and the planar frame seal area. When subjected to a sintering temperature and the pressure of a static weight, the fiber mat can support some additional pressure enabling the glass seal to thin more on the portion that is not in contact with the fiber mat. Upon cooling to room temperature, a seal with a desired angular deviation from planarity planarity is provided. Alternately, a weight with a machined bevel can be applied wherein the bevel of the weight provides an inward and upward inclination to the seal during or after sintering. It is noted that a seal of varying thickness can be created by using a non-planar weight or non-uniform pressure during sealing.

The seal area portion of the electrolyte sheet that extends upwardly and inwardly toward the active area of the electrolyte sheet can in one embodiment extend upwardly and inwardly in a generally planar manner. To that end, the seal portion can extend upwardly and inwardly at any desired angle relative to the generally planar bottom surface of the frame or support member. However, in an exemplary embodiment, the seal area portion of the electrolyte sheet extends upwardly and inwardly at a positive angular deviation from planarity θ that is in the range of from 0.5 degrees to 20 degrees, relative to the reference plane R. In a more preferred embodiment, the seal area of the electrolyte sheet extends upwardly and inwardly or downwardly and inwardly at an angular deviation from planarity θ in the range of from 1 degree to 10 degrees. In this embodiment, the height deviation from the seal-electrolyte interface from the reference plane R on the outer periphery) of the seal-electrolyte interface is zero (i.e., distance, Dₒᵤₜ=0). However, in this embodiment, deviation from the seal-electrolyte interface from the reference plane R is the angular deviation from planarity θ. In this embodiment the angle θ is formed by the difference in height of the seal-electrolyte interface from the outer periphery of the seal-electrolyte interface to the inner periphery of the seal electrolyte interface (Dᵢₙ−Dₒᵤₜ=Dᵢₙ)

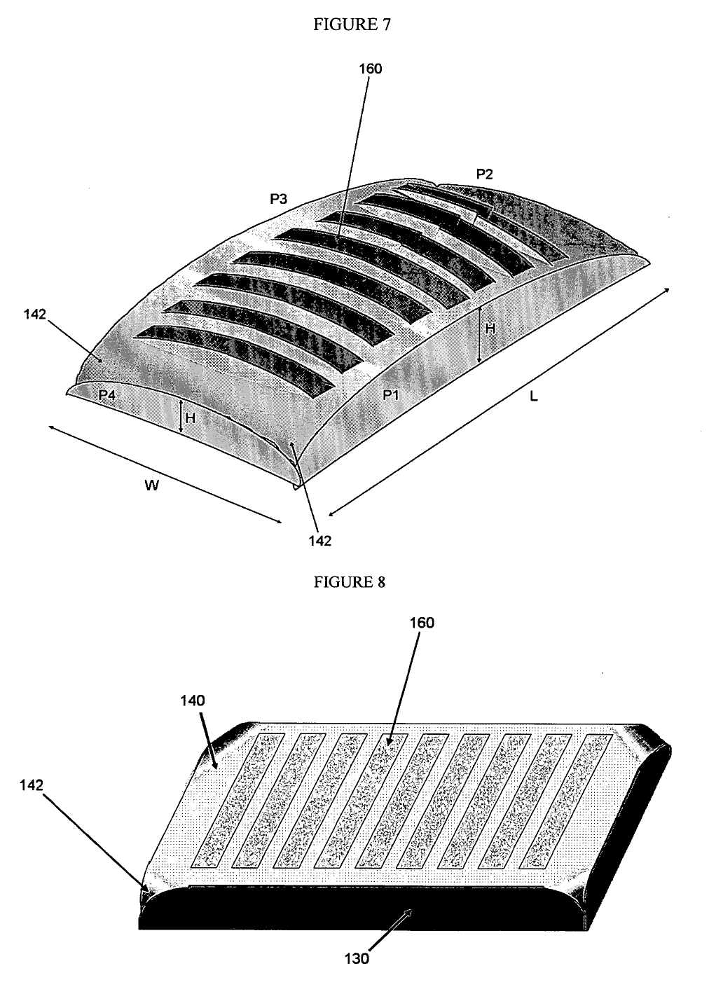

In another embodiment, the seal portion of the electrolyte sheet can extend upwardly and inwardly in a generally non-planar manner. For example, the seal portion of the electrolyte sheet can extend upwardly and inwardly in a generally arcuate manner. With reference to FIG. 7, an exemplary arcuately extending seal portion of an electrolyte sheet is shown. As illustrated, the arcuately extending seal portion 142 can provide an electrolyte sheet 140 forming an elliptical dome shape. As exemplified, the seal area can be defined by the smooth curves denoting the intersection of four vertical planes (P1, P2, P3, and P4), with a rectangular projection on a perpendicular plane. According to this embodiment, the electrolyte sheet can take the form or shape similar to a portion of a prolate or oblate spheroid. Still further, it should be understood that an arcuate or angular deviation from planarity can have any desired radius configured to provide a desired shape or form to the electrolyte sheet. However, in one embodiment, it is preferred for the oblate or prolate spheroid shape to have a height “H” in the range of from 0.1 mm to 5 mm, and more preferably in the range of 0.5 mm to 3 mm, over a an approximate width “W” or length “L” of at least about 10 cm. In this embodiment, the maximum deviation from the seal-electrolyte interface from the reference plane, R, is the distance D from the reference plane on the outer periphery of the seal-electrolyte interface. In addition there can be an angular deviation from the reference plane R over some or all of the seal-electrolyte interface.

According to still another embodiment, it should also be understood that the entire seal area of the electrolyte sheet can extend upwardly and inwardly toward the active area of the electrolyte sheet, as shown for example in FIG. 7 described above. Alternatively however, in another embodiment, it is contemplated that only a portion of the seal area will extend upwardly and inwardly toward the active area of the electrolyte sheet. For example, as shown in FIG. 8, the four corners of the seal area 142 in a rectangular device can be constructed and arranged such that only the corner portions of the electrolyte sheet seal area extend upwardly and inwardly toward the active area 160 of the electrolyte sheet 140. As shown, the remaining portions of the seal area and even the active area of the electrolyte sheet can be substantially planar. In this embodiment, the maximum deviation from the seal-electrolyte interface from the reference plane, R, is the distance D from the reference plane on the outer periphery of the seal-electrolyte interface. In addition there can be an angular deviation for the reference plane over some or all of the interface.

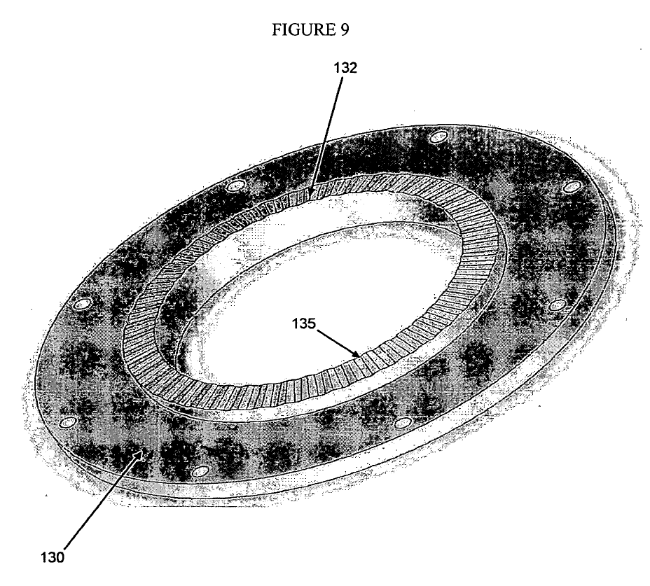

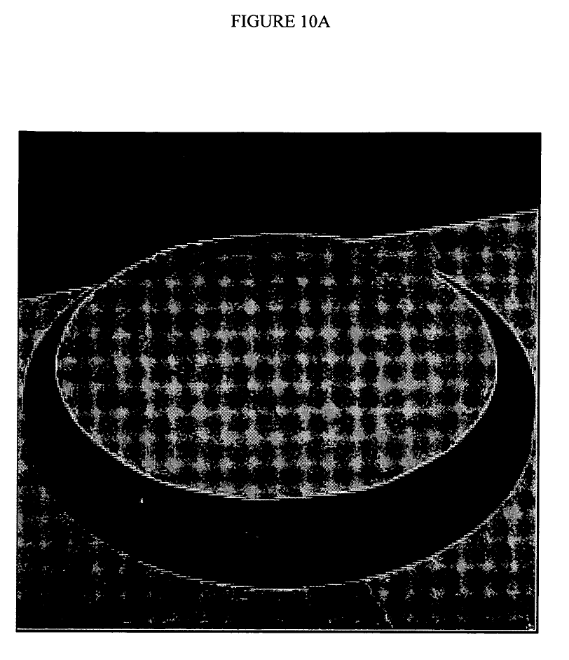

In still another embodiment of the present invention, the frame or support member can be provided having a textured or irregular top seal surface portion. In one embodiment, the textured or irregular top support surface can be comprised of a series of smooth height perturbations as shown for example in FIG. 9. In particular, FIG. 9 depicts an exemplary circular frame member 130, having a top support surface 132 comprised of a plurality of smooth height perturbations 135 with an angular deviation of planarity (a circular bevel). The textured surface can, for example, be constructed in correlation to a predetermined wavelength of the self wrinkles that can result from differential coefficients of thermal expansion between the various device parts. This can be utilized to lower stresses which, in turn, can result in a lower failure/fracture probability, and a more thermal shock resistant, reliable, durable device. The irregular or textured frame support surface can also enable greater differential pressure across the electrolyte membrane. It should be understood that according to this embodiment, the desired configuration of the periodic height perturbation surface will depend, at least in part, on the size and configuration of the frame and the various materials used in the device parts, i.e., the frame, electrolyte sheet, and the seal composition. However, in one embodiment, it is preferred for the corrugations have a period (also referred to wavelength herein) in the range of 150 micron to 10 cm, more preferably a 1 mm to 5 cm, and even more preferably 3 mm to 4 cm. Additionally, the height h or amplitude of the corrugation can, for example be in the range of 0.1 mm to 5.0 mm high, preferably 0.15 mm to 0.5 mm. Generally longer wavelengths are preferred for thicker electrolyte, for example corrugation periods of/mm to 10 mm may be preferred for electrolyte 5 microns in thickness, while 10 mm to 100 mm periods may be preferred for electrolyte 50 microns in thickness.

Other aspects of the present invention are methods for manufacturing the electrochemical device assemblies, and solid oxide fuel cell devices comprising, for example, each of the seal structure embodiments recited herein for reducing and/or eliminating deformation and failure of fuel cell components, either individually or in various combinations. Accordingly, the exemplary methods according to the embodiments of the present invention generally comprise providing a frame as described herein, having a support surface for the seal. A device comprising an electrolyte sheet as described herein can be provided. At least a portion of the electrolyte sheet is connected to at least a portion of the frame support surface with a seal composition, such that the portion of the interface of the seal-electrolyte sheet connected to the frame, and hence the electrolyte, extends upwardly toward a second portion of the electrolyte sheet. To that end, in one embodiment, the seal composition as described herein can be first applied to the support surface of the frame and then subsequently contacted with the electrolyte sheet. Alternatively, the step of connecting at least a portion of the electrolyte sheet to at least a portion of the frame top support surface can first comprise applying the seal composition to the ceramic electrolyte sheet and then contacting the applied seal composition with the frame support surface. Also, in an alternative embodiment, at least a portion of the electrolyte sheet is connected to at least a portion of the frame and the electrolyte-seal interface deviates from planarity with respect to the reference plane R of the electrolyte-seal interface by at least 0.1 mm in the direction normal to the reference plane R of the electrolyte-seal interface, where the deviation from planarity extends normal to the reference plane or inwardly toward the active surface region of the electrolyte sheet.

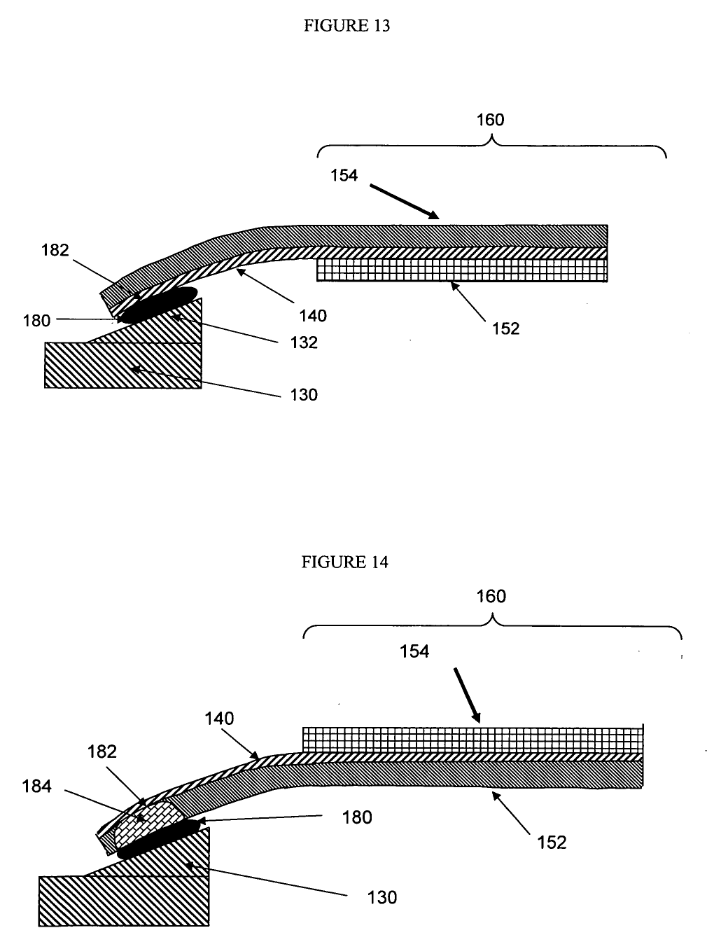

The upwardly and inwardly extending seal area can also apply to electrode (152) supported, generally planar, solid oxide fuel cell devices. The angular deviation from planarity of an electrode supported fuel cell device can, in one embodiment, be provided by the geometry of the frame or support member. For example, as shown in FIG. 13, a frame or support member 130 can be formed such that the top support surface of the frame 132 extends upwardly and inwardly toward the active area 160 of the electrode supported electrolyte 140. For example, in the exemplary embodiment shown, the frame 130 can be machined to provide a beveled support surface 132. A substantially uniformly thick amount of the ceramic bonding agent or seal material 180 can be provided on at least a portion of the beveled top surface 132 of the frame or support so that it is interposed between frame support surface 132 and the seal area of the electrode supported electrolyte sheet. If desired, the bevel can further be provided across the entire support surface (e.g., top surface that supports the seal) portion of the frame. Alternatively, for example, the bevel can be present on only a portion of the frame or its support portion. For example, in a rectangular frame, a bevel can be provided across one, two, three or even all frame edges. If a stamped metal frame is used then the bevel can be stamped into the frame such that the metal thickness remains constant but an angular deviation from planarity (or bevel) is imposed by the bend in the metal. In this embodiment, angular deviation from the seal-electrolyte interface 182 from the reference plane R is measured by the angle θ.

Also, the upwardly and inwardly extending seal area can also apply to electrode supported, generally planar, solid oxide fuel cell devices where the electrode support faces the seal composition. The angular deviation from planarity of an electrode supported fuel cell device can, in one embodiment, be provided by the geometry of the frame or support member. For example, as shown in FIG. 14 a frame or support member 130 can be formed such that the top support surface of the frame 132 extends upwardly and inwardly toward the active area 160 of the electrode supported electrolyte 140. For example, in the exemplary embodiment shown, the frame 130 can be machined to provide a beveled support surface 132. A substantially uniformly thick bead of the ceramic bonding agent or seal material 180 can be provided on at least a portion of the beveled top surface 132 of the frame or support so that it is interposed between frame support surface 132 and the seal area of the electrode supported electrolyte sheet. In some embodiments, the seal composition intrudes, 184, into the porous support electrode 152, closing the pores of the electrode, making a gas tight seal. Again, if desired, the bevel can further be provided across the entire support surface (e.g., top surface that supports the seal) portion of the frame. Alternatively, for example, the bevel can be present on only a portion of the frame or its support portion. For example, in a rectangular frame, a bevel can be provided across one, two, three or even all frame edges. If a stamped metal frame is used then the bevel can be stamped into the frame such that the metal thickness remains constant but an angular deviation from planarity (or bevel) is imposed by the bend in the metal. In this embodiment, angular deviation from the seal-electrolyte interface 182 from the reference plane R is measured by the angle θ.

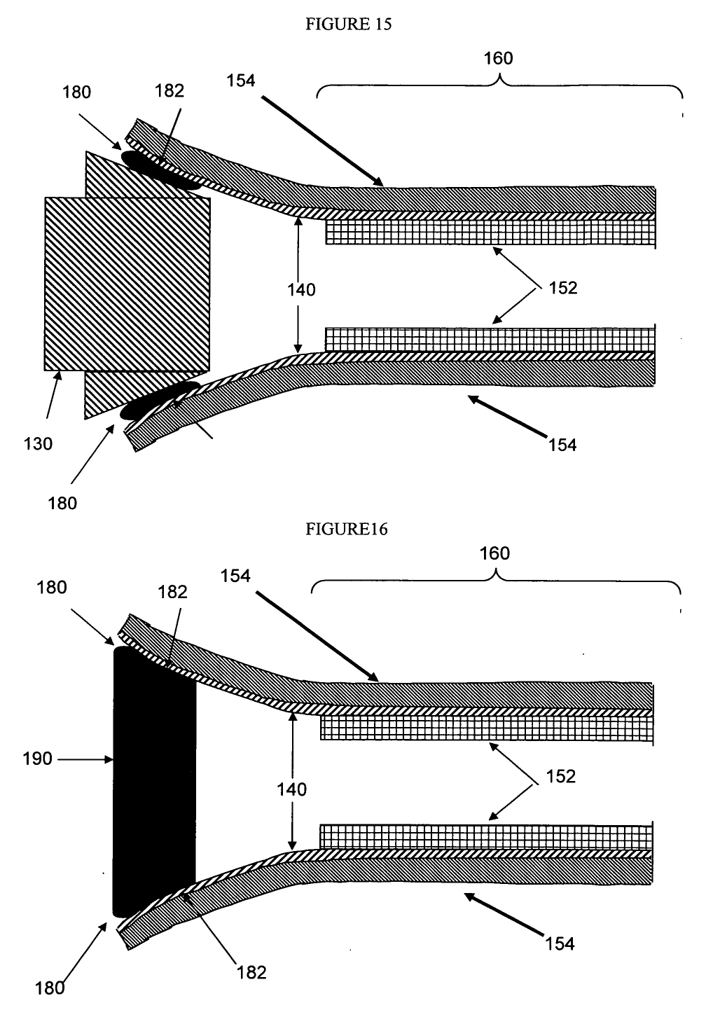

The downwardly and inwardly extending seal area can apply to either electrolyte supported or electrode supported, generally planar, solid oxide fuel cell devices. The angular deviation from planarity of an electrode supported fuel cell device can, in one embodiment, be provided by the geometry of the frame or support member. For example, as shown in FIG. 15 a frame or support member 130 can be formed such that the top support surface of the frame 132 extends downwardly and inwardly toward the active area 160 of the electrode supported electrolyte 140. The geometry is mirrored for the bottom electrochemical device. For example, in the exemplary embodiment shown, the frame 130 can be machined to provide a beveled support surface 132. A substantially uniformly thick bead of the ceramic bonding agent or seal material 180 can be provided on at least a portion of the beveled top and bottom surfaces 132 of the frame or support so that it is interposed between frame support surface 132 and the seal area of the electrode supported electrolyte sheet. If desired, the bevel can further be provided across the entire support surface (e.g., top surface that supports the seal) portion of the frame. Alternatively, for example, the bevel can be present on only a portion of the frame or its support portion. For example, in a rectangular frame, a bevel can be provided across one, two, three or even all frame edges. If a stamped metal frame is used then the bevel can be stamped into the frame such that the metal thickness remains constant but an angular deviation from planarity (or bevel) is imposed by the bend in the metal. In this embodiment, angular deviation from the seal-electrolyte interface 182 from the reference plane R is measured by the angle θ.

As stated above, the downwardly and inwardly extending seal area can apply to either electrolyte supported or electrode supported, generally planar, solid oxide fuel cell devices. The angular deviation from planarity of an electrode supported fuel cell device can, in one embodiment, be provided by the geometry of the seal (i.e., the frame or support-member may be formed by the seal, and thus no other frame may be necessary). For example, as shown in FIG. 16 a frame or support member 190 can be formed from the seal composition such that the seal-electrolyte interface 182 extends downwardly and inwardly, or upwardly and inwardly (not shown) toward the active area 160 of the electrode supported electrolyte 140. For example, in the embodiment shown, the seal composition 190 can be formed to provide an electrolyte support surface that has an angular deviation from planarity. A substantially uniform, very thick “bead” of the ceramic bonding agent or seal material 190 can be provided to form at least a portion of the non planar top and bottom surfaces of the seal/frame, so that it is both the frame support surface and the seal area (of the electrode supported or electrolyte supported device). If desired, the deviation from planarity can further be provided across the entire seal-frame surface. Alternatively, for example, the angular deviation from planarity can be present on only a portion of the seal/frame. For example, in a rectangular seal/frame, a deviation form planarity can be provided across one, two, three or even all seal/frame edges. In this embodiment, angular deviation from the seal-electrolyte interface 182 from the reference plane R is measured by the angle θ.

Accordingly, an electrochemical device assembly according to one embodiment, comprises: (A) a seal having at least one electrolyte support surface; (B) at least one electrolyte sheet situated on said seal and comprising an electrochemically active area and an electrochemically inactive area, wherein the inactive area comprises a seal area and a streetwidth area, and wherein the streetwidth area is interposed between the active surface region and the seal area; and the seal contacts at least a portion of the electrolyte sheet seal area; wherein at least a portion of the seal-electrolyte sheet interface deviates from planarity by extending either (i) upwardly and inwardly or (ii) downwardly and inwardly toward the active surface region of the electrolyte sheet. According to this embodiment the seal is also a frame. Preferably, at least a portion of the seal electrolyte sheet interface contacting the seal composition deviates from planarity with respect to a reference plane of the seal-electrolyte interface (i) with angular deviation of least 0.5 degrees, where the angular deviation from planarity extends inwardly toward the active area of the electrolyte sheet; and/or (ii) such that at least a portion of the electrolyte sheet contacting the seal composition deviates from planarity with respect to the reference plane by at least 0.1 mm in the direction normal to the reference plane. The seal composition may extend either (i) arcuately upward and toward the active region of the electrolyte sheet, or (ii) arcuately and downwardly and toward the active region of the electrolyte sheet. In some embodiments, the seal and/or or electrolyte surfaces that contact one another may be textured. Furthermore, in some embodiments, the seal has substantially periodic, variable thickness.

To make a multiple cell solid oxide fuel cell device, electrolyte (zirconia) sheets can be sintered from tape cast sheets. Prior to sintering via holes can be punched through the electrolyte sheets. The sintering can occur at temperatures in the range of 1300° C.-1500° C. After a pore free sintered electrolyte sheet is obtained, multiple anodes, for example nickel oxide-zirconia anodes, can be printed using screen printing techniques and screen printing inks. The anodes are sintered on the electrolyte, for example, at temperatures of about 1300-1400° C. in air for about 2 hrs. Multiple cathodes, for example of LSM and zirconia, can then be screen printed on the electrolyte sheet (which already has anode(s) printed thereon) using screen printing inks. The cathodes are sintered, for example, at temperatures of about 1200° C.-1300° C. for about 1/2-2 hrs. Via fill of a highly conductive composition, such as Ag—Pd, Au—Pt—Pd, LSC, can be printed and fired on the electrolyte sheet containing the anodes and cathodes. Bus bars and via pads of a highly conductive composition, such as Ag—Pd, Au—Pt—Pd can be printed and fired, at a lower temperature. Current collectors of a highly conductive composition, for example Ag—Pd plus ceramic, or Au—Pt—Pd can be printed and fired at an even lower temperature to maintain the current collector porosity.

### EXAMPLES

The following examples are put forth so as to provide those of ordinary skill in the art with a complete disclosure and description of how the solid oxide fuel cell devices claimed herein can be made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred. Unless indicated otherwise, parts are parts by weight, temperature is ° C. or is at ambient temperature, and pressure is at or near atmospheric

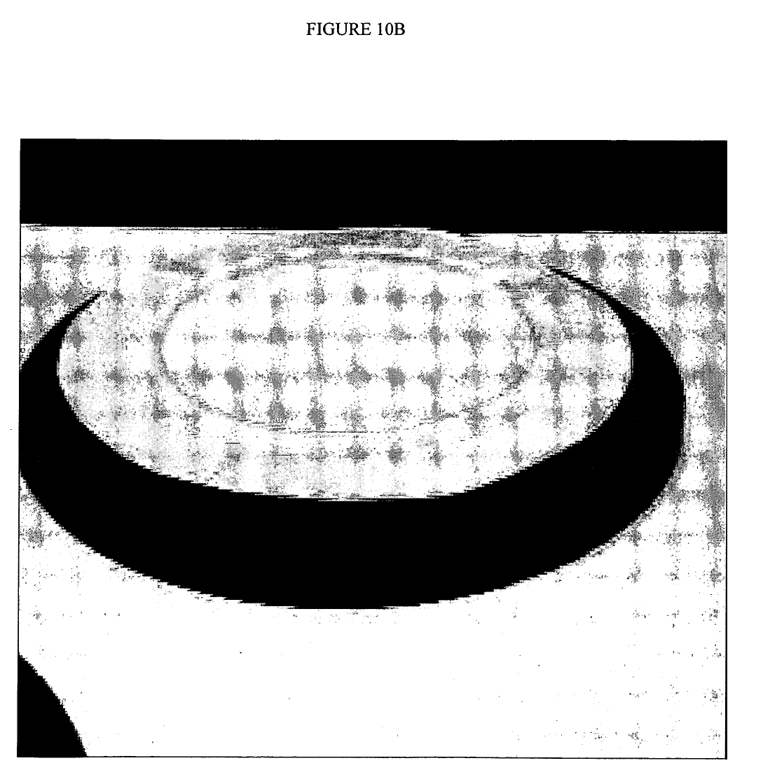

For the following examples, three circular frames for pressure testing were machined from 446 Stainless Steel having inner diameters of 3 inches. The three frames had a top surface seal portion having a 0 degree angular deviation from planarity, 2.5 degree angular deviation from planarity and 5 degree angular deviation from planarity, respectively. Three weights with the same inner diameter and matching angular deviation from planarity were also machined. Electrolyte disks (circular electrolyte sheets) were manufactured from a composition 3 mole % yttria partially stabilized zirconia further comprising very minor alumina and silica impurities. These electrolyte sheets or discs were approximately 20 microns thick. The electrolyte disks were bonded to the frames using a glass/ceramic seal composition comprised of the glass and ceramic particles along with binders and solvents and having a thermal expansion coefficient lower than the electrolyte. The seal paste approximately 1-3 mm thick was laid down on the steel frame and allowed to harden by driving off the solvent at slightly elevated temperature. The electrolyte disks were then placed directly on and over the paste. An alumina fiber mat cushion (felt layer) was then placed on the electrolyte and the weight placed on the fiber matt putting light compression on the electrolyte. The sealing assembly was then heated at a temperature in the range of 700° C.-1000° C. and the seal was formed by sintering under light pressure for several hours. FIG. 10A and FIG. 10B illustrate the frames with 2.5 degree and 5.0 degree angular deviations from planarity respectively, the frames being successfully sealed to the electrolyte disks.

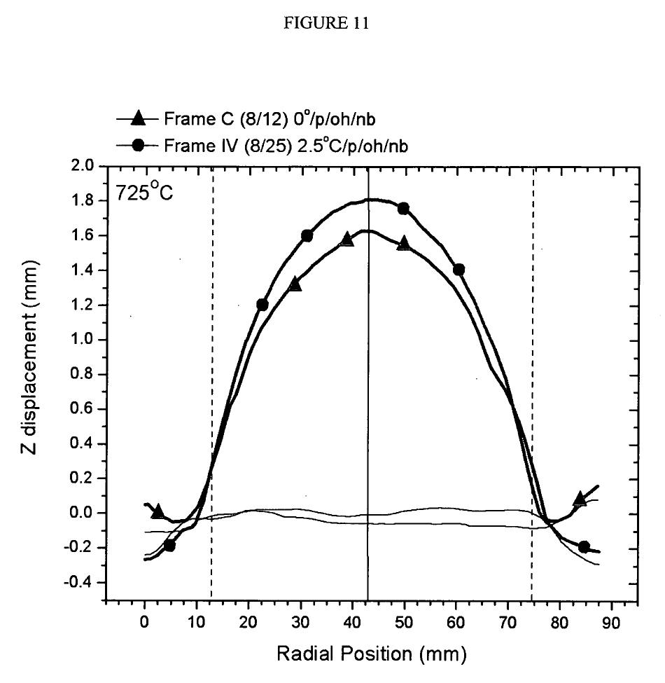

An optical stereoscope was then used to measure the degree of deflection that occurred when the two manufactured assemblies with a seal-electrolyte sheet interface at zero degree angular deviation from planarity and a 2.5 degree angular deviation from planarity were subjected to a gas pressure at 725° C. The deflection data obtained by the stereoscopic measurement analysis is set forth in FIG. 11. As shown, when subjected to pressure and temperature, the electrolyte sheet with the 0 degree angular deviation from planarity exhibited a very sharp bend just outside the seal area. In contrast, although the 2.5 degree angular deviation from planarity sample also exhibited a bend, the radius of this bend was much larger indicating that the degree of deformation was much less severe. Thus, the resulting stresses in the assembly with 2.5 degree angular deviation from planarity will be lower.

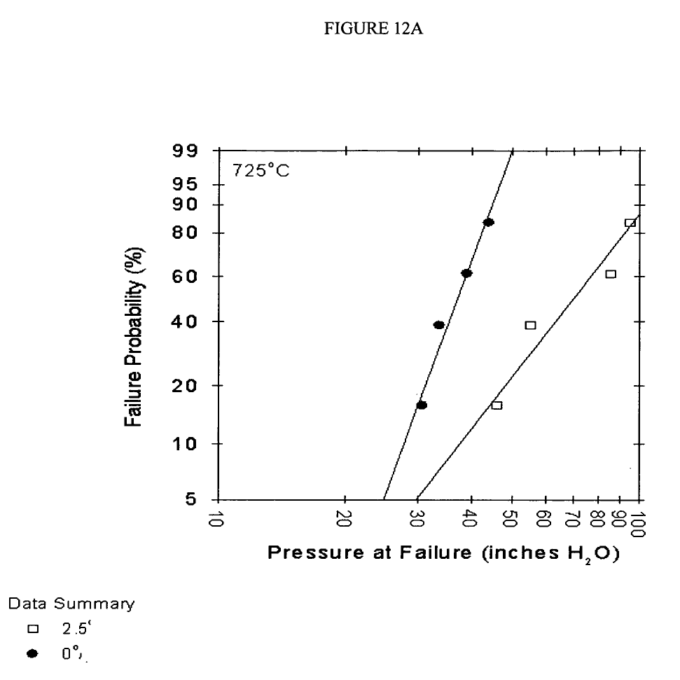

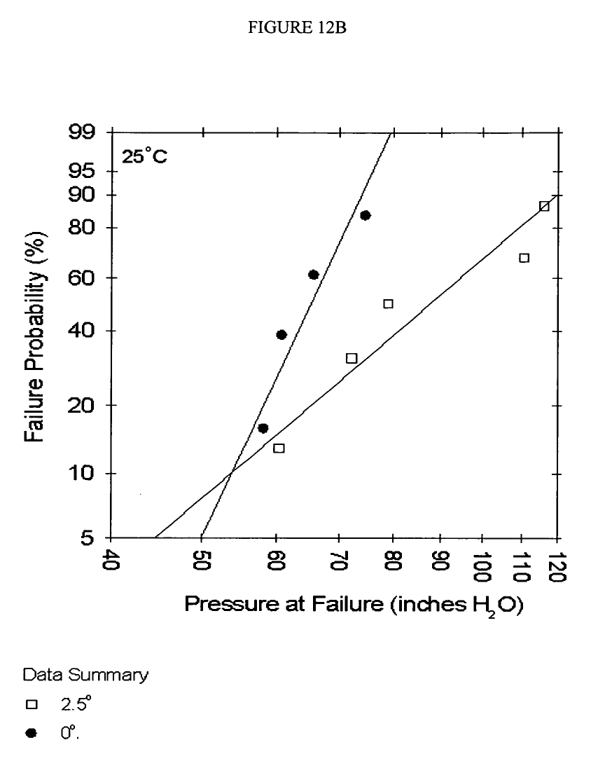

Still further, FIGS. 12A and 12B provide pressure to rupture data for the zero and 2.5 degree angular deviation from planarity circular test frames manufactured as described above, having 20 micron thick 3 mole % yttria partially stabilized zirconia electrolyte disk sealed to 3 inch inner diameter frames. FIG. 13A shows data obtained at 725° C. Based upon four samples, the test frames having the 2.5 degree angular deviation from planarity exhibited a mean pressure to fracture of 78.9 inches of water. In contrast, also based upon four samples, the test frames having the zero degree angular deviation from planarity exhibited a mean pressure to fracture of 36.8 inches of water. Thus, according to this example, the 2.5 degree angular deviation from planarity test frame exhibited about a 90% greater pressure to fracture than the test frame having a zero angular deviation from planarity.

FIG. 12B shows similar pressure to fracture data obtained at ambient temperature conditions of about 25° C. Based upon five samples, the test frames having the 2.5 degree angular deviation from planarity exhibited a mean pressure to fracture of 87.6 inches of water. In contrast, based upon four samples, the test frames having the zero degree angular deviation from planarity exhibited a mean pressure to fracture of 64.9 inches of water. Thus, according to this example, the 2.5 degree angular deviation from planarity test frame exhibited about a 35% greater pressure to fracture than the test frame having a zero angular deviation from planarity. The data reflected in FIG. 12A and FIG. 12B indicate the improved strength and resistance to rupture or fracture that the inventive seal geometry can provide when an electrolyte sheet is subjected to internal pressure.

### Example 1

Two rectangular fuel cell devices with dimensions of 11.8 cm by 28.4 cm and containing 15 rectangular printed cells (i.e., anode/cathode pairs) of about 8 mm×8 cm were sealed to a machined frame with rectangular central opening, thus forming a packet. The frames were made of 430 or 446 stainless steel with a flat planar sealing surface (support surface). The first device was sealed to the frames first (via sintering) and the second device was sealed to the plane next, in a similar manner. The device orientation was such that anode containing surfaces of the two devices were facing one another. More specifically, in order to seal the first device to the frame, the sealing material was applied around the periphery of the frame opening. The seal material was then heated to evaporate the solvents. Two thin flexible ceramic spacers that where slightly larger than the frame thickness (by about 1 mm) were positioned in the middle of the inner opening of the frame to support the fuel cell device and to induce directionality to the bow of the fuel cell device. The fuel cell device was then placed on top of the dried seals. Two felt layers were then placed over the seal material. The first felt layer was approximately 5 mm wide and extended beyond the seal material both on the inward side of the seal (i.e., the side facing the active area of the fuel cell device(s)) and on the outward side. The second felt layer was applied over the first felt layer. The second felt layer was approximately 3 mm in width and extended primarily towards the outward side from the seal with the outer extent of the top felt layer coinciding with the outward extent of the lower felt layer. A steel weight, in approximately the shape of the lower gasket and approximately 1/2″ thick was placed upon the two felt layers. The seal material was then sintered. When fired or sintered, the seal electrolyte interface was generally raised in the upward and inward direction, greater than 1 and less than 10 degrees with respect to the reference plane the reference plane. That is, preferably, the angular deviation from planarity is 1°≦θ≦10°. A second device was applied to the opposite side of the frame so as to give an anode facing anode orientation. Then, the second device was attached and sealed to the frame in the same manner as the first device. Thin ceramic felt spacers were again used to provide a directionality to the bow of the device and remained within the framed packet. These two devices had a seal-electrolyte interface angle of greater than 1 degree but less than 10 degrees with respect to the reference plane. The two fuel cell devices (i.e., electrolyte sheets, each sandwiched between a plurality of electrode pairs, with electrical via interconnects connecting the anodes and cathodes of each device) sealed to the frame thus formed a fuel cell packet. This packet with two devices was heated provided with fuel and power cycled through ten thermal cycles from approximately 200° C. to 725° C. without failure.

### Example 2

3A flat electrolyte sheet was made in a shape of 12×15 cm rectangle. A silicate based seal composition (with an expansion near that of the zirconia electrolyte) was deposited as a thin cylindrically shaped tube of about 0.5-1 mm in diameter as a powder paste by a robotic syringe dispensing machine around the seal area (in this example the outside 5 mm) of the electrolyte sheet. The seal paste was made with powdered glass or powdered glass-ceramic precursor, and organic vehicles and binders. The majority of the organic materials in the seal paste were eliminated by drying/oxidation of the seal bead on the electrolyte sheet at about 180° C. in air for several hours. A 446 stainless steel “window” frame about 0.3 mm thick in a rectangle of about 20 cm×16 cm, with a center opening (rectangular cut out of about 11 cm×14 cm) was provided. The flat electrolyte sheet with the powdered glass-ceramic seal material was carefully aligned and placed on the frame. More specifically, an alumina ceramic felt ring was placed on the electrolyte sheet above seal material. Oval alumina tubes of about 5 cm length were then placed perpendicular to the seal material with a spacing of about 1.5 cm between the tubes. A weight was placed on the rods. Because of the rods, the weigh was applied in a periodic fashion to the seal-electrolyte interface, resulting in the desired periodicity of the seal (i.e., the seal had a periodic, variable thickness, and thus in the periodicity of the seal-electrolyte interface. This mounting assembly was fired at about 800-850° C. for 2 hours with a 3 hour room temperature to sintering temperature ramp rate and a similar cooing rate until the slower natural furnace cooing rate took over. This procedure also resulted in the portion of the initially flat electrolyte on the seal-electrolyte interface to assume a periodic, variable height. This seal and electrolyte with a periodic, variable height on a frame was measured by a laser topography system and found to have a seal-electrolyte interface height which deviated from a reference plane by greater than 0.1 mm.

### Example 3

Yet another flat electrolyte sheet was manufactured in a 12×15 cm rectangle. A silicate based seal composition (with an expansion near that of the zirconia based electrolyte) was deposited as a thin cylindrically shaped tube of about 0.5 mm-1 mm in diameter as a powder paste by a robotic syringe dispensing machine around the seal area (in this example the outside 5 mm) of the electrolyte sheet. The paste was made with powdered glass or powdered glass-ceramic precursor, and organic vehicles and binders. The majority of the organic materials in the seal composition were eliminated by drying/oxidation of the seal material on the electrolyte sheet at about 180° C. for several hours. A 446 stainless steel “window” frame about 0.3 mm thick in a rectangular shape (20 cm×16 cm) with a rectangular cut out of 11×14 cm was provided. The flat electrolyte with the powdered glass-ceramic material was then carefully aligned and placed on the 446 “window” frame with the glass-ceramic material facing the frame. An alumina ceramic felt ring was provided and aligned on the electrolyte sheet above seal material. A weight was provided such that the weight's inner dimension rested right on the inner edge of the seal material. The weight had a rounded inner edge with a radius of about 5 mm. This mounting assembly was fired at about 850° C. for 2 hours (with a 3 hour room temperature to sintering temperature ramp rate, and a similar cooing rate until the slower natural furnace cooing rate took over). This procedure resulted in an electrolyte with a non-planar, seal-electrolyte interface with an angle of about 3 degrees (greater than 1 degree but less than 10 degrees) for the seal-electrolyte interface with respect to the reference plane as measured by a laser measurement system.

Lastly, it is to be understood that various modifications and variations can be made to the compositions, articles, devices, and methods described herein. Other embodiments of the compositions, articles, devices, and methods described herein will be apparent from consideration of the specification and practice of the compositions, articles, devices, and methods disclosed herein. It is intended that the specification and examples be considered as exemplary. For example, the embodiments described herein are drawn to exemplary fuel cell configurations where the expected pressure differential between the interior and exterior of a device packet is positive, i.e. where the pressure exterior to the packet is lower. As such, the seal area of the electrolyte sheet is described as having a positive angular deviation from planarity and extending upwardly and inwardly towards the active region of the electrolyte sheet. However, it should be understood that the present invention also contemplates fuel cell configure-ations where the expected pressure differential between the interior and exterior of a device packet is negative, i.e. where the pressure exterior to the packet is higher. As such, the seal area of the electrolyte sheet according to those embodiments could have a negative angular deviation from planarity and extend downward and inward towards the active region of the electrolyte sheet.

1. An electrochemical device assembly, comprising:
(A) at least one electrolyte sheet comprising an electrochemically active area and an electrochemically inactive area, wherein the inactive area comprises a seal area and a streetwidth area, and wherein the streetwidth area is interposed between the active surface region and the seal area;
(B) a seal, said seal contacting at least a portion of the outer periphery of the electrolyte sheet seal area and forming seal-electrolyte sheet interface, wherein
(a) at least a portion of seal-electrolyte sheet interface deviates from planarity with respect to a reference plane of the seal-electrolyte interface by extending either (i) upwardly and inwardly or (ii) downwardly and inwardly toward the active surface region of the electrolyte sheet and all corners of the electrolyte sheet are pointing in different directions from one another; and/or
(b) all sides of seal-electrolyte sheet interface deviate from planarity with respect to a reference plane of the seal-electrolyte interface by extending either (i) upwardly and inwardly or (ii) downwardly and inwardly toward the active surface region of the electrolyte sheet.

2. An electrochemical device according to claim 1, further comprising:
a frame having at least one support surface;
wherein said seal comprises a seal composition interposed between and contacting (i) at least a portion of the frame support surface, and (ii) at least a portion of the electrolyte sheet seal area; said seal composition and said portion of the electrolyte sheet seal area forming a seal-electrolyte interface.

3. An electrochemical device assembly, comprising:
a frame having at least one seal support surface;
at least one electrolyte sheet comprising an electrochemically active area and an electrochemically inactive area, wherein the inactive area comprises a seal area and a streetwidth area, and wherein the streetwidth area is interposed between the active surface region and the seal area; and
a seal comprising a seal composition interposed between and contacting at least a portion of the support surface and at least a portion of the electrolyte sheet seal area, forming a seal-electrolyte interface;
wherein (a) at least a portion of the seal electrolyte sheet interface contacting the seal composition deviates from planarity with respect to a reference plane of the seal-electrolyte interface and all corners of the electrolyte sheet are pointing in different directions from one another; and/or (b) all sides of seal-electrolyte sheet interface deviate from planarity with respect to a reference plane of the seal-electrolyte interface;
and (i) the angular deviation is least 0.5 degrees, where the angular deviation from planarity extends inwardly toward said active area of said electrolyte sheet; and/or (ii) at least a portion of the electrolyte sheet contacting the seal composition deviates from planarity with respect to said reference plane by at least 0.1 mm in the direction normal to said reference plane.

4. The electrochemical device assembly of claim 3, wherein the portion of the support surface contacting the seal material deviates from planarity by extending either (i) upwardly and inwardly or (ii) downwardly and inwardly toward the active region of the electrolyte sheet.

5. The electrochemical device assembly of claim 3, wherein the portion of the support surface contacting the seal composition is substantially planar and wherein the seal has a wedge shaped cross-section.

6. The electrochemical device assembly of claim 3, wherein at least a portion of the seal area of the electrolyte sheet contacting the seal composition deviates from planarity by extending either (i) upwardly and inwardly or (ii) downwardly and inwardly toward the active region of the electrolyte sheet at an angle in the range of 0.5 degrees to 20 degrees, relative to the reference plane.

7. The electrochemical device assembly of claim 3, wherein at least a portion of the seal area of the electrolyte sheet contacting the seal composition extends either (i) arcuately upward and toward the active region of the electrolyte sheet, or (ii) arcuately and downwardly and toward the active region of the electrolyte sheet.

8. The electrochemical device assembly of claim 3, wherein said portion of the frame support surface contacting the seal composition is textured.

9. The electrochemical device assembly of claim 3, wherein at least a portion of the frame support surface contacting the seal composition is substantially planar and wherein the seal has substantially periodic, variable thickness.

10. The electrochemical device assembly of claim 3, wherein the portion of the support surface contacting the seal composition deviates from planarity by over 0.1 mm.

11. The electrochemical device assembly of claim 3, wherein the frame support surface contacting the seal composition deviates from planarity by over 0.1 mm in smooth curves of greater than 2 cm radius.

12. The electrochemical device assembly of claim 3, wherein the active region of the electrolyte sheet is substantially planar.

13. The electrochemical device assembly of claim 3, wherein the active region of the electrolyte sheet is substantially non-planar.

14. The electrochemical device assembly of claim 3, wherein the electrolyte sheet is flexible.

15. The electrochemical device assembly of claim 3, wherein the electrolyte sheet is less than 100 microns in thickness.

16. A solid oxide fuel cell system comprising the electrochemical device assembly of claim 1, and further including at least one anode and at least one cathode.

17. A method for manufacturing an electrochemical device assembly; comprising:
providing a frame having a seal support surface;
providing a device comprising an electrolyte sheet; and
connecting all peripheral sides of the electrolyte sheet to at least a portion of the frame seal support surface with a seal composition, such that the portion of the electrolyte sheet connected to the seal composition deviates from planarity by not less than 0.5 degrees, where the angular deviation from planarity extends inwardly toward the active surface region of the electrolyte sheet with respect to the reference plane; or (ii) not less than 0.1 mm in the direction perpendicular to the reference plane.

18. The method of claim 17, wherein the step of connecting at least a portion of the electrolyte sheet to at least a portion of the seal support surface comprises first applying the seal composition to the ceramic electrolyte sheet; and then contacting the applied seal composition with the seal support surface.

19. The method of claim 17, wherein a portion of the frame support surface contacting the seal composition: (i) extends upwardly or downwardly toward the active surface portion of the electrolyte sheet with respect to the reference plane, or (ii) is substantially parallel to the reference plane, and wherein the electrolyte sheet is connected to the frame support surface by a seal with a wedge shaped cross-section.

20. The method of claim 17, wherein a portion of the frame support surface connected to the seal composition is textured.

21. The method of claim 17, wherein the portion of the frame support surface contacting the seal composition is substantially parallel to the reference plane and wherein the electrolyte sheet is connected to the frame top support surface by a varying thickness seal composition and that varying thickness is created by using a non-planar weight or non-uniform pressure during sealing.

22. A method for manufacturing an electrochemical device assembly; comprising:
providing a device comprising an electrolyte sheet; and
contacting least a portion of the electrolyte sheet to at least a portion of the frame seal support surface with a seal composition and forming seal-electrolyte interface, such that: the portion of the electrolyte sheet connected to the seal composition deviates from planarity with respect to a reference plane of the seal-electrolyte interface (i) by not less than 0.5 degrees, where the angular deviation from planarity extends inwardly toward the active surface region of the electrolyte sheet with respect to the reference plane; or (ii) not less than 0.1 mm in the direction perpendicular to the reference plane,
and wherein (a) all corners of the electrolyte sheet are pointing in different directions from one another; and/or (b) said seal is contacting the outer periphery of the electrolyte sheet and all sides of seal-electrolyte sheet interface deviate from planarity with respect to a reference plane of the seal-electrolyte interface.
